(19) United States
(12) Patent Application Publication
(10) Pub. No.: US 2008/0079863 A1
(43) Pub. Date: Apr. 3, 2008

(54) Liquid Crystal Display Device

(76) Inventors: Dae-yoon Jung, Yongin-si (KR); Seong-sik Choi, Seoul (KR)

Correspondence Address: Frank Chau, Esq.;F. CHAU & ASSOCIATES, LLC, 130 Woodbury Road, Woodbury, NY, 11797, US

(21) Appl. No.: 11/865,459

(22) Filed: Oct. 1, 2007

(30) Foreign Application Priority Data
Sep. 29, 2006 (KR) 10-2006-0096322

(51) Int. Cl. G02F 1/1333

(52) U.S. Cl. 349/58

(57) ABSTRACT

A liquid crystal display device, includes a liquid crystal panel, a light guide plate which is provided behind the liquid crystal panel and comprises an exit surface facing the liquid crystal panel, a reflecting surface opposite the exit surface, a pair of incident surfaces opposite to each other, and a pair of side surfaces opposite to each other, a pair of light sources provided along the respective incident surfaces of the light guide plate, and a pair of cover members, each of the cover members comprises a first part accommodating one of the light sources with one of the incident surfaces cover member and a second part extending from the first part and facing the reflecting surface of the light guide plate, and over which the liquid crystal panel is seated.

### CROSS-REFERENCE TO RELATED APPLICATIONS

This application claims priority from Korean Patent Application No. 2006-0096322, filed on Sep. 29, 2006 in the Korean Intellectual Property Office, the disclosure of which is incorporated herein by reference in its entirety.

### BACKGROUND OF INVENTION

1. Field of Invention

Embodiments of the present invention relate to a liquid crystal display device, and more particularly to a liquid crystal display having light guide plate covers supporting a liquid crystal panel.

2. Description of Related Art

Typically, a liquid crystal display (LCD) device adjusts a light transmittance of a liquid crystal cell according to image signal information and forms an image on a liquid crystal panel using light transmitted from a backlight unit.

The liquid crystal panel and the backlight unit are accommodated into a space between an upper cover and a lower cover that are coupled to each other. The liquid crystal panel is seated in a mold frame provided inside the upper cover and the lower cover.

The LCD device, with a configuration of the upper cover, the lower cover, and the mold frame is manufactured at an increased cost due to the complexity of the configuration.

### SUMMARY OF THE INVENTION

According to an embodiment of the present invention, a liquid crystal display device, comprises a liquid crystal panel, a light guide plate which is provided behind the liquid crystal panel and comprises an exit surface facing the liquid crystal panel, a reflecting surface opposite to the exit surface, a pair of incident surfaces opposite to each other, and a pair of side surfaces opposite to each other, a pair of light sources provided along the respective incident surfaces of the light guide plate, and a pair of cover members, each of the cover members comprises a first part accommodating one of the light sources with one of the incident surfaces cover member and a second part extending from the first part and facing the reflecting surface of the light guide plate, and over which the liquid crystal panel is seated.

According to an embodiment of the present invention, the liquid crystal panel is seated over the first part, and each of the cover members further comprises a first panel guide which protrudes from the first part and faces one side part of the liquid crystal panel.

According to an embodiment of the present invention, the liquid crystal display device further comprises an elastic member provided between the first part of each of the cover members and the liquid crystal panel.

According to an embodiment of the present invention, the elastic member comprises a silicon tape.

According to an embodiment of the present invention, the liquid crystal display device further comprises a pair of side covers, respectively provided along the side surface of the light guide plate.

According to an embodiment of the present invention, each of the side covers extends along one of the side surfaces of the light guide plate.

According to an embodiment of the present invention, the liquid crystal panel is seated over the side covers.

According to an embodiment of the present invention, each of the cover members further comprises a third part which extends from the second part and faces the side surface of the light guide plate.

According to an embodiment of the present invention, each of the side covers comprises a fourth part which faces one of the side surfaces of the light guide plate and a fifth part which extends from the fourth part and faces the exit surface of the light guide plate, the liquid crystal panel is seated over the fifth part, and the third part and the fourth part are coupled to each other.

According to an embodiment of the present invention, each of the side covers comprises a second panel guide which extends from the fifth part and faces one side part of the liquid crystal panel.

According to an embodiment of the present invention, the liquid crystal display device further comprises an optical film provided between the light guide plate and the liquid crystal panel, wherein a part of the optical film is provided between the light guide plate and the fifth part.

According to an embodiment of the present invention, the fourth part is provided between the third part and the light guide plate.

According to an embodiment of the present invention, the liquid crystal display device further comprises a pair of light source reflecting plates which are respectively provided between each of the light sources and the cover members, and reflects light emitted from the light sources to one of the incident surfaces of light guide plate.

According to an embodiment of the present invention, the liquid crystal display device further comprises a reflecting plate which is provided between the light guide plate and the second part of the cover member.

According to an embodiment of the present invention a liquid crystal display device, comprises a liquid crystal panel, a light guide plate which is provided behind the liquid crystal panel and comprises an exit surface facing the liquid crystal panel, a reflecting surface opposite to the exit surface, a pair of incident surfaces opposite to each other, and a pair of side surfaces opposite to each other, a pair of light sources provided along the respective incident surfaces of the light guide plate, a pair of cover members, each of the cover members comprises a first part accommodating one of the light sources with one of the incident surfaces, cover member a second part extending from the first part and facing the reflecting surface of the light guide plate, and a third part extending from the second part and facing the side surface of the light guide plate, and a pair of side covers, each side cover provided along one of the side surfaces of the light guide plate and couples the pair of the cover members.

According to an embodiment of the present invention, the liquid crystal panel is seated over the cover members and the side covers.

According to an embodiment of the present invention, the liquid crystal display device further comprises an elastic member provided between the liquid crystal panel and each of the cover members, and between the liquid crystal panel and each of the side covers.

According to an embodiment of the present invention, the elastic member comprises a silicon tape.

According to an embodiment of the present invention, each of the side covers extends along a respective one of the side surfaces of the light guide plate.

According to an embodiment of the present invention, at least a part of each of the cover members faces the exit surface of the light guide plate.

According to an embodiment of the present invention, the liquid crystal display device further comprises a panel guide facing a side part of the liquid crystal panel, the panel guide formed in the cover members and the side covers, respectively.

According to an embodiment of the present invention, a liquid crystal display device comprises a liquid crystal panel, a light guide plate provide behind the liquid crystal panel, a pair of light sources provided along opposite incident surfaces of the light guide plate, a pair of cover members facing the light guide plate, wherein the respective light sources are disposed between the light guide plate and the cover members, and a pair of side covers which couples the pair of cover members, the liquid crystal panel being seated over the cover members and the side covers.

### BRIEF DESCRIPTION OF THE DRAWINGS

The present invention will become apparent and more readily appreciated from the following description of exemplary embodiments, taken in conjunction with the accompanying drawings, in which:

FIG. 1 is an exploded perspective view illustrating a liquid crystal display device according to an exemplary embodiment of the present invention;

FIG. 2 is a perspective view illustrating the liquid crystal display device according to FIG. 1;

FIG. 3 is an enlarged perspective view illustrating a cover member in the liquid crystal display device according to FIG. 1;

FIG. 4 is an enlarged perspective view illustrating a side cover in the liquid crystal display device according to FIG. 1;

FIG. 5 is a sectional view taken along V-V of FIG. 2 in a liquid crystal display device according to FIG. 1;

FIG. 6 is a sectional view taken along VI-VI of FIG. 2;

FIG. 7 is a sectional view taken along VII-VII of FIG. 2;

FIGS. 8A through 8E illustrate an assembling method of the liquid crystal display device according to FIG. 1;

FIGS. 9 and 10 are is sectional views taken along VI-VI and VII-VII of FIG. 2 in a liquid crystal display device according to an exemplary embodiment of the present invention;

FIG. 11 an enlarged perspective view illustrating a cover member in a liquid crystal display device according to an exemplary embodiment of the present invention;

FIG. 12 is a sectional view taken along VII-VII of FIG. 2 in the liquid crystal display device according to FIG. 11;

FIG. 13 is a sectional view taken along V-V of FIG. 2 in a liquid crystal display device according to FIG. 11;

FIG. 14 an enlarged perspective view illustrating a cover member in a liquid crystal display device according to an exemplary embodiment of the present invention;

FIG. 15 an enlarged perspective view illustrating a cover member in a liquid crystal display device according to an exemplary embodiment of the present invention;

### DETAILED DESCRIPTION OF EXEMPLARY EMBODIMENTS

Reference will now be made in detail to embodiments of the present invention, examples of which are illustrated in the accompanying drawings, wherein like reference numerals refer to like elements throughout.

In this specification, a description that a first element A and a second element B ‘face’ each other does not preclude a case where at least a third element C is provided between the elements A and B.

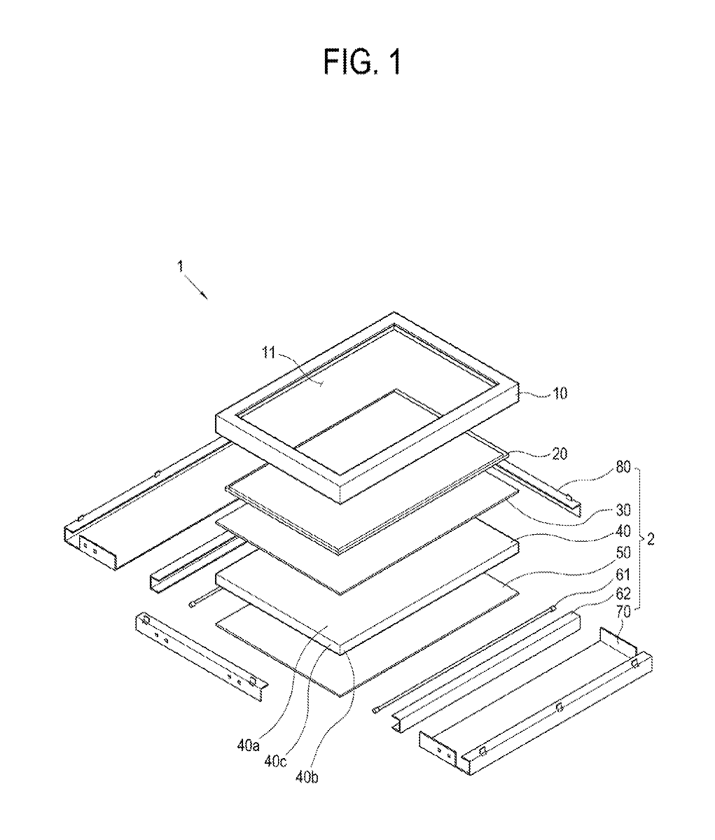

A liquid crystal display (LCD) device 1 according to an exemplary embodiment of the present invention will be described with reference to FIGS. 1 through 7.

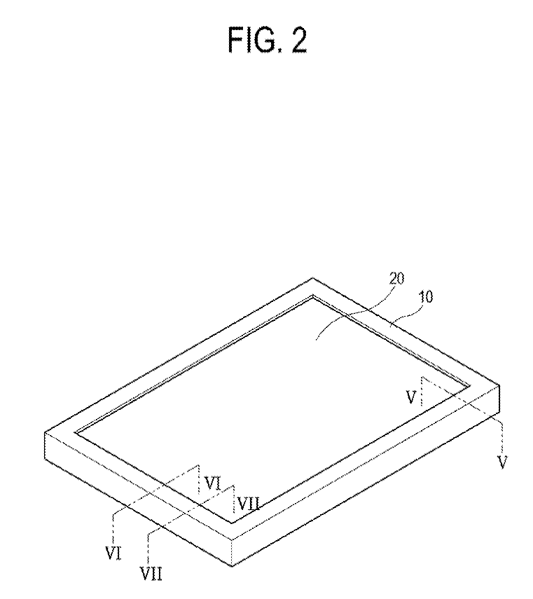

Referring to FIGS. 1 and 2, the LCD device 1 includes a liquid crystal panel 20 and a backlight unit 2 provided behind the liquid crystal panel 20. The backlight unit 2 includes an optical film 30 provided behind the liquid crystal panel 20, a light guide plate 40 provided behind the optical film 30, a reflecting plate 50 provided behind the light guide plate 40, a light source 61 and a light source reflecting plate 62 which face an incident surface 40b of the light guide plate 40, a cover member 70 accommodating the light source reflecting plate 62, and a side cover 80 which faces a side surface 40c of the light guide plate 40.

The liquid crystal panel 20 has an approximately rectangular shape. The light source 61 is provided along a longer side of the liquid crystal panel 20. The side cover 80 is provided along a shorter side of the liquid crystal panel 20.

The liquid crystal panel 20 and the backlight unit 2 are accommodated into a front cover 10.

The front cover 10 has an approximately rectangular shape. Further, the front cover 10 includes an opening 11 which reveals a display area of the liquid crystal panel 20. The front cover 10 may be formed of aluminum, stainless steal, or another suitable material.

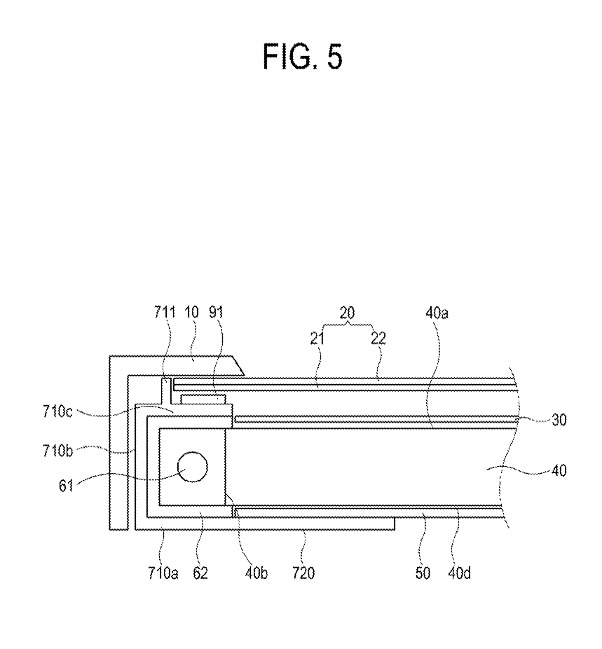

Referring to FIG. 5, the liquid crystal panel 20 includes a first substrate 21 having a thin film transistor (TFT) formed thereon, and a second substrate 22 which faces the first substrate 22. The second substrate 22 may include a color filter. A liquid crystal layer (not shown) may be provided between the first substrate 21 and the second substrate 22.

Returning to FIG. 1, the optical film 30 has an approximately rectangular shape. The optical film 30 may include at least one of a diffusion film, a prism film, a reflective polarizer film, and a passivation film. A plurality of optical films 30 may be provided.

The light guide plate 40, which has an approximately rectangular shape, is formed of an acrylic resin such as a polymethylstyrene resin or a polymethyl-methacrylate (PMMA) resin. The polymethylstyrene resin is a copolymer of a methylmethacrylate resin and a styrene resin. The light guide plate 40 uniformly provides light emitted from the light source 61 to the optical film 30. The light guide plate 40 includes an exit surface 40a provided toward the liquid crystal panel 20, a pair of the incident surfaces 40b facing the light source 61 (e.g., respective light sources 61 disposed at the incident surfaces 40b), a pair of the side surfaces 40c facing the side cover 80 (e.g., respective side covers 80 disposed at the side surfaces 40c), and a reflecting surface 40d which is provided opposite the exit surface 40a.

The reflecting plate 50, which is provided below the light guide plate 40, reflects the light emitted from the light source 61 back to the light guide plate 40. The reflecting plate 50 may include a plastic material such as polyethylenterephthalate (PET) or polycarbonate (PC).

Aluminum or the like may be coated on a surface of the reflecting plate 50 facing the light guide plate 40.

The light source 61, which is provided along the incident surface 40b of the light guide plate 40, may employ a cold cathode fluorescent lamp (CCFL) or an external electrode fluorescent lamp (EEFL). Alternatively, the light source 61 may employ a light-emitting diode (LED).

The light source reflecting plate 62 accommodates the light source 61. The light source reflecting plate 62 reflects the light emitted from the light source 61 to the light guide plate 40. The light source reflecting plate 62 may be formed of PET.

A pair of the cover members 70 is provided. The cover members 70 may be formed of aluminum, stainless steel or another suitable material.

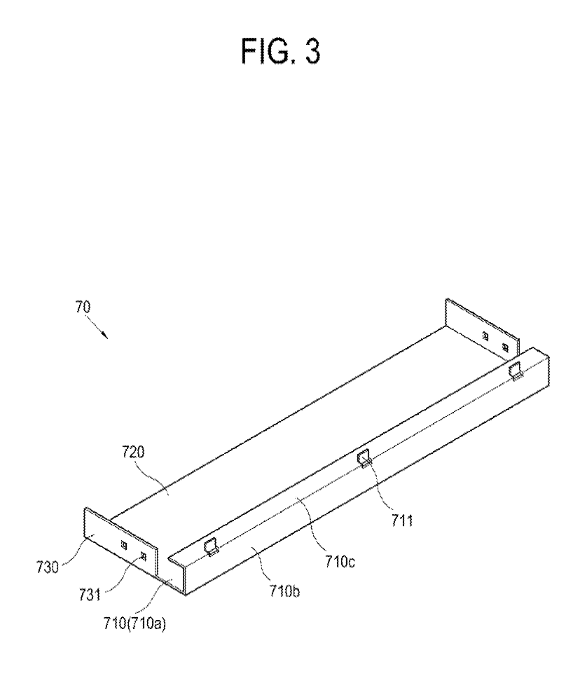

Referring to FIG. 3, each of the cover members 70 includes a first part 710 which accommodates the light source reflecting plate 62, a second part 720 which extends from the first part 710 to face the reflecting surface 40d of the light guide plate 40, and a third part 730 which extends from the second part 720 to face the side surface 40c of the light guide plate 40. The third part 730 includes a first coupling unit 731. The first coupling unit 731 includes a coupling hole.

The first part 710 includes a first sub part 710a coupled to the second part 720, a second sub part 710b provided substantially parallel with the incident surface 40b of the light guide plate 40, and a third sub part 710c provided above the light guide plate 40.

Referring to FIG. 5, a first elastic member 91 is disposed on the third sub part 710c. In particular, the first elastic member 91 is continuously provided on the third sub part 710c as one body. Alternatively, the first elastic member 91 may be discontinuously provided on the third sub part 710c. The first elastic member 91 may be formed of, for example, a silicon tape, rubber or the like.

An end part of the longer side of the liquid crystal panel 20 is seated over the third sub part 710c. The first elastic member 91 is provided between the liquid crystal panel 20 and the third sub part 710c. The liquid crystal panel 20 contacts the first elastic member 91. The first elastic member 91 substantially prevents the liquid crystal panel 20 from being abraded due to direct contact with the cover member 70. Further, the first elastic member 91 protects the liquid crystal 20 from impacts such as shaking and substantially prevents foreign materials from permeating into a space between the liquid crystal panel 20 and the cover member 70.

A first panel guide 711 is provided on the third sub part 710c. The first panel guide 711 protrudes in a direction substantially vertical to the planar direction of the surface of the liquid crystal panel 20. The first panel guide 711, which faces a side surface of the liquid crystal panel 20, substantially prevents the liquid crystal panel 20 from moving in the planar direction thereof.

The second part 720 extends below from the light guide plate 40. The second part 720 covers opposite side parts of the reflecting plate 50 as viewed from beneath, and a center part of the reflecting plate 50 is exposed.

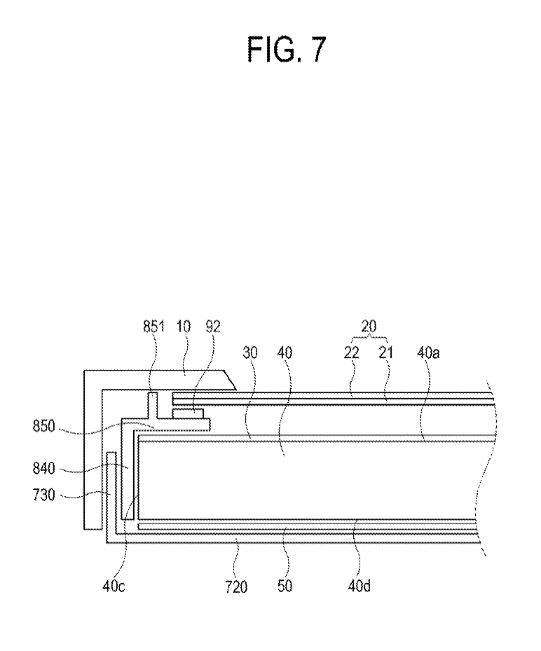

Referring to FIG. 7, the third part 730 faces the side surface 40c of the light guide plate 40.

A pair of the side covers 80 are provided. The side covers 80 may be formed of aluminum, stainless steel, or another suitable material.

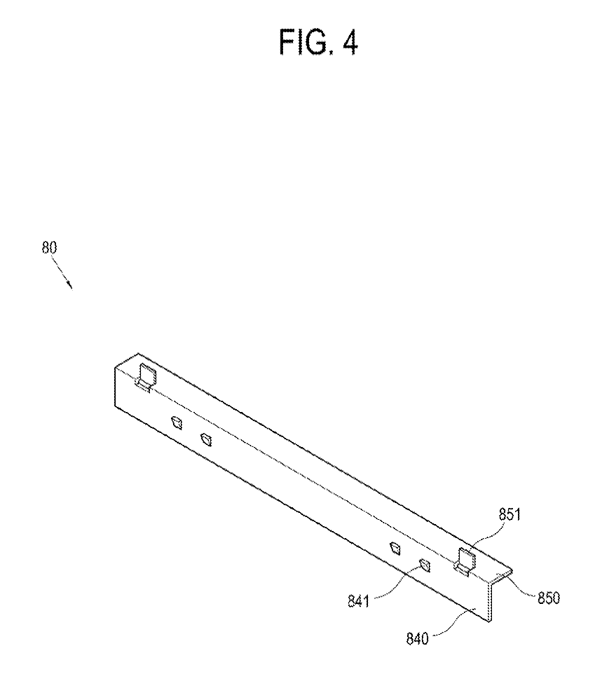

Referring to FIGS. 4, 6 and 7, each of the side covers 80 includes a fourth part 840 which faces the side surface 40c of the light guide plate 40, and a fifth part 850 which extends from the fourth part 840 to partially cover the exit surface 40a of the light guide plate 40.

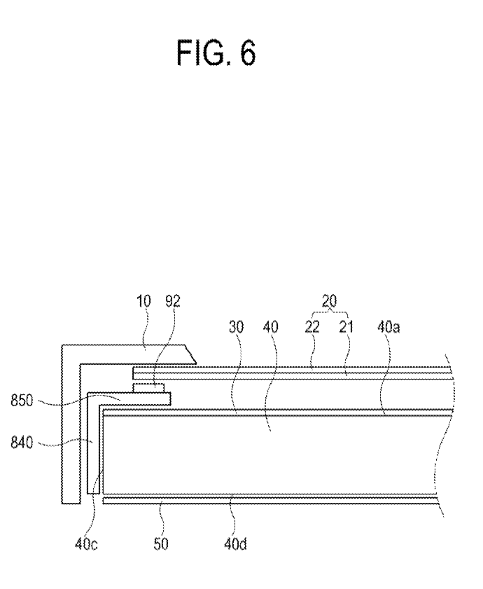

The third part 730 of each cover member 70 faces a portion of the side surface 40c of the light guide plate 40. The fourth part 840 of each side cover 80 faces the whole side surface 40c of the light guide plate 40. Accordingly, the side surface 40c, except end parts thereof, is surrounded by the side covers 80 (referring to FIG. 6). Other end parts of the side surface 40c are surrounded by the cover members 70 and/or the side covers 80 (referring to FIG. 7).

The fourth part 840 includes a second coupling unit 841 as a coupling protrusion. The second coupling unit 841 is coupled to the first coupling unit 731 of each cover member 70. By coupling the first coupling unit 731 with the second coupling unit 841, the cover members 70 are coupled to each other through the side covers 80. Further, a movement of the cover members 70 is restricted in a lengthwise direction of the side covers 80.

Referring to FIG. 7, the fourth part 840 of each side cover 80 is provided between the light guide panel 40 and the third part 730. An end part of the optical film 30 is provided between the light guide panel 40 and the fifth part 850. The optical film 30 is disposed with the fifth part 850 and the light guide plate 40 disposed above and below thereof, respectively.

As illustrated in FIGS. 6 and 7, the fifth part 850 includes a second elastic member 92. In particular, the second elastic member 92 is continuously provided on the fifth part 850 as one body. Alternatively, the second elastic member 92 may be discontinuously provided on the fifth part 850. The second elastic member 92 may be formed of, for example, a silicon tape, rubber or the like.

An end part of the shorter side of the liquid crystal panel 20 is seated over the fifth part 850. The second elastic member 92 is provided between the liquid crystal panel 20 and the fifth part 850. The liquid crystal panel 20 directly contacts the second elastic member 92. The second elastic member 92 substantially prevents the liquid crystal panel 20 from being abraded due to direct contact with the side cover 80. Further, the second elastic member 92 protects the liquid crystal 20 from impacts such as shaking and substantially prevents foreign materials from permeating into a space between the liquid crystal panel 20 and the side cover 80.

A second panel guide 851 is provided on the fifth part 850. The second panel guide 851 protrudes in the direction substantially vertical to the planar direction of the surface of the liquid crystal panel 20. The second panel guide 851, which faces a side surface of the liquid crystal panel 20, substantially prevents the liquid crystal panel 20 from moving in a planar direction thereof.

According to an embodiment of the present invention, the liquid crystal panel 20 is stably seated in the cover member 70 and the side cover 80 without an additional mold frame. The first panel guide 711 and the second panel guide 851, respectively support four sides of the liquid crystal panel 20, and thus, substantially prevent the liquid crystal panel 20 from moving in the planar direction thereof.

In the LCD device 1 an additional mold frame and an additional cover that faces the whole reflecting surface 40d of the light guide plate are not needed.

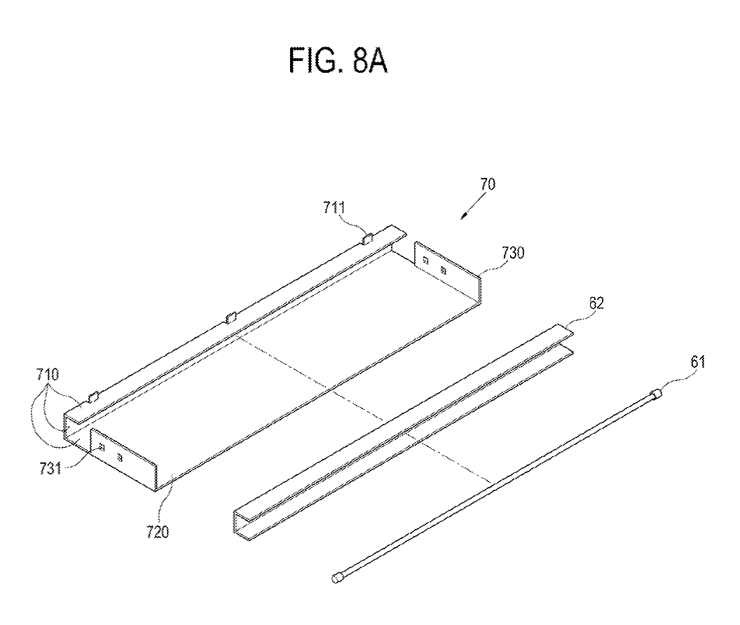

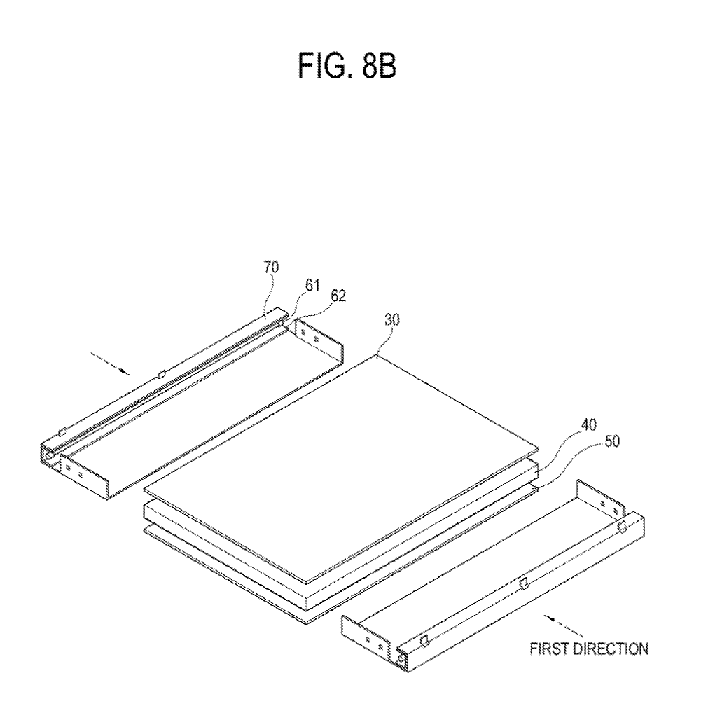

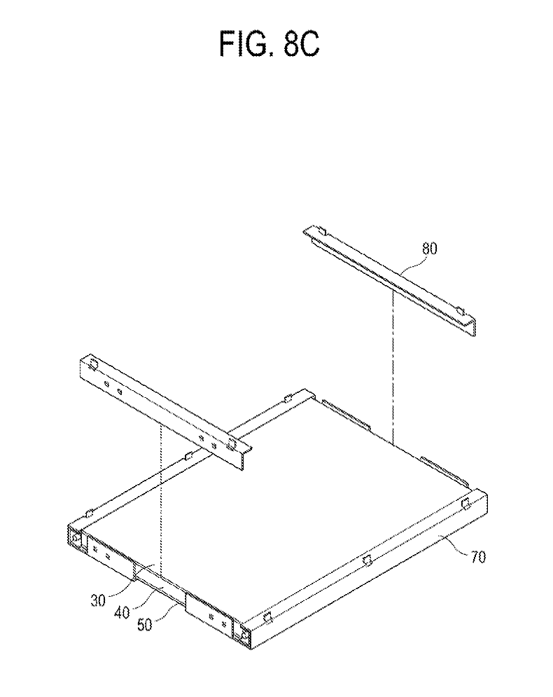

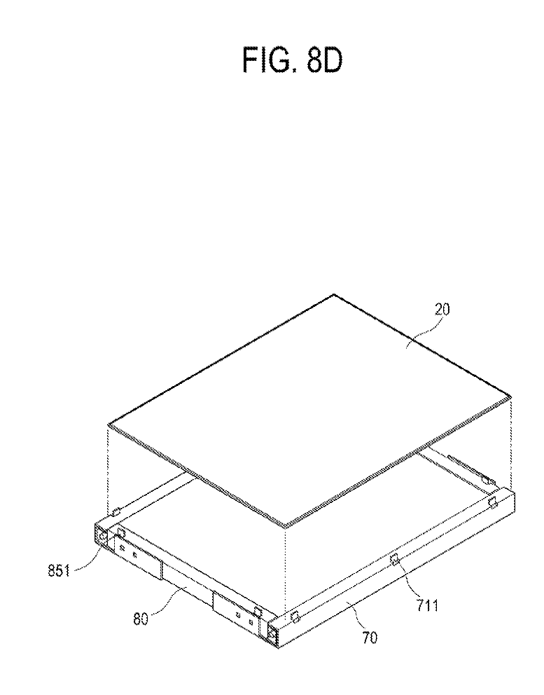

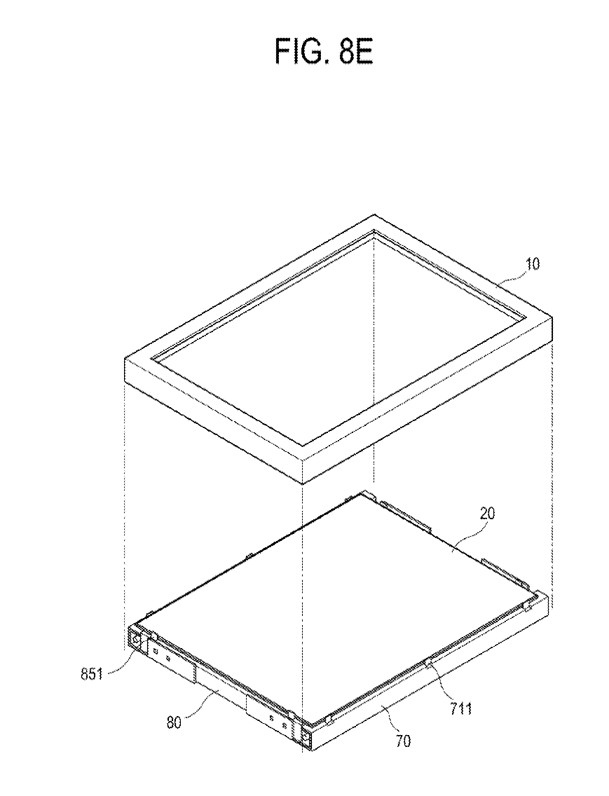

An assembling method of the LCD device 1 according to an exemplary embodiment of the present invention will be described with reference to FIGS. 8A through 8E.

As illustrated in FIG. 8A, the light source reflecting plate 62 and the light source 61 is inserted into the first part 710 of the cover member 70.

As illustrated in FIG. 8B, the reflecting plate 50, the light guide plate 50 and the optical film 30 are provided between the pair of cover members 70. The pair of cover members 70 respectively approach along a first direction (e.g., one cover approaching in the first direction and another cover approaching opposite the first direction).

As illustrated FIG. 8C, the side cover 80 is inserted into a space between opposite side surfaces 40c of the light guide plate 40 and the cover member 70. The first coupling unit 731 and the second coupling unit 841 are coupled to each other so that the cover member 70 is coupled to the side cover 80 while the side cover 80 is inserted. Through the side cover 80, the opposite cover members 70 are coupled to each other. Accordingly, a movement of the cover member 70 is restricted along the first direction.

As the side cover 80 is completely inserted, as illustrated in FIG. 8D, the fifth part 850 of the side cover 80 presses end parts of the optical film 30 and the light guide plate 40, respectively. Accordingly, a movement of the optical film 30 from the side cover 80 is restricted and a movement of the light guide plate 40 is substantially prohibited in a direction vertical to a planar surface direction thereof.

As illustrated in FIG. 8D, the liquid crystal panel 20 is seated in the cover member 70 and the side cover 80. The first elastic member 91 and the second elastic member 92 are attached on the cover members 70 and the side covers 80, respectively. It does not matter which one between the first elastic member 91 and the second elastic member 92 is attached first.

The longer side of the liquid crystal panel 20 is seated in the cover members 70, and the shorter side of the liquid crystal panel 20 is seated in the side cover 80. A side part of the liquid crystal panel 20 faces the first panel guide 711 and the second panel guide 841, respectively while the liquid crystal panel 20 is seated.

The front cover 10 is assembled as illustrated in FIG. 8E. While the front cover 10 is assembled, the front cover 10 is coupled to the cover member 70 and/or the side cover 80. Further, the first panel guide 711 and the second panel guide 841, respectively restrict movement of the liquid crystal panel 20, to thereby perform a stable operation of assembling the front cover 10.

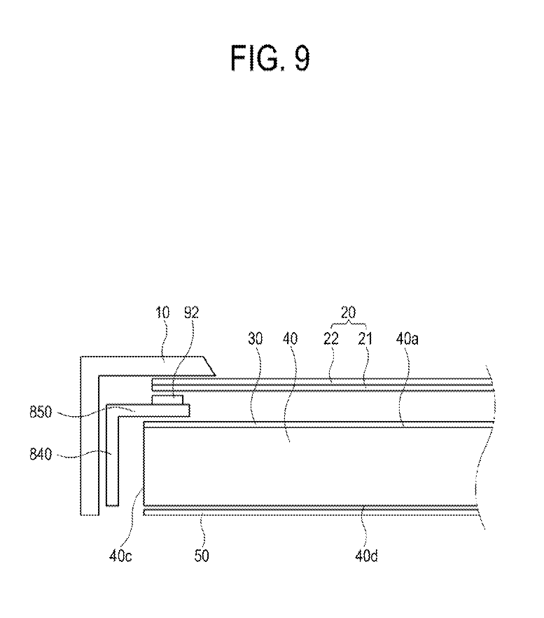

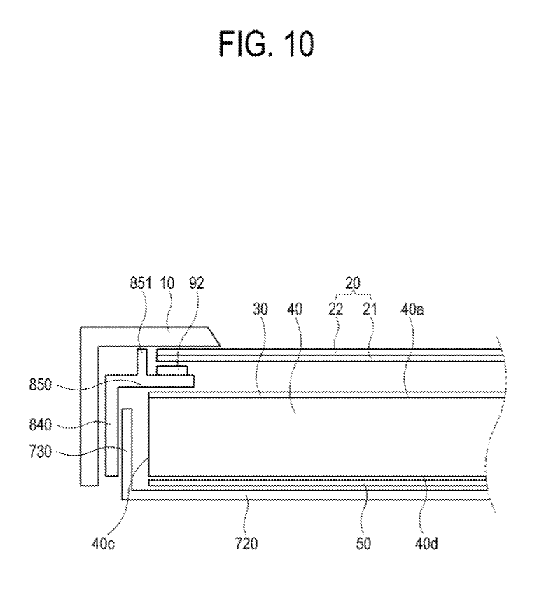

An LCD device according to an exemplary embodiment of the present invention will be described with reference to FIGS. 9 and 10, where FIG. 9 is a sectional view taken along VI-VI of FIG. 2, and FIG. 10 is a sectional view taken along VII-VII of FIG. 2.

A third part 730 of each cover member 70 is provided between a fourth part 840 of each side cover 80 and a light guide plate 40. Each side cover 80 is coupled to an external surface of each cover member 70. Accordingly, the side covers 80 can be conveniently assembled.

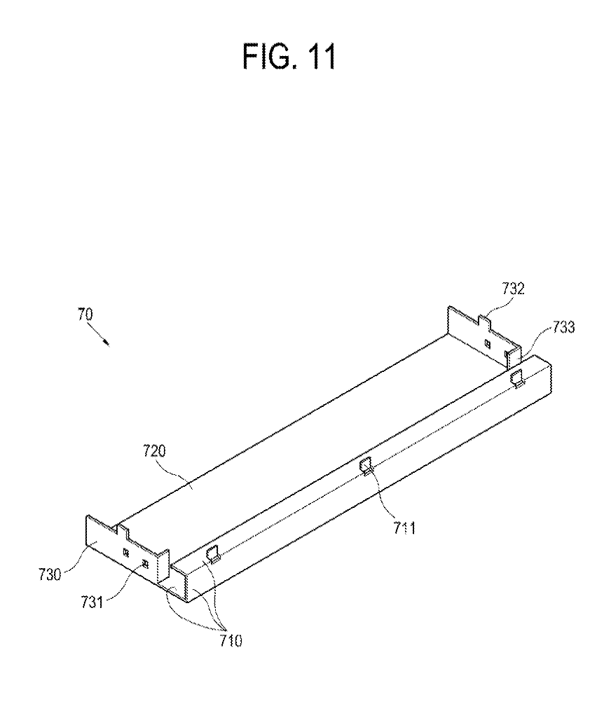

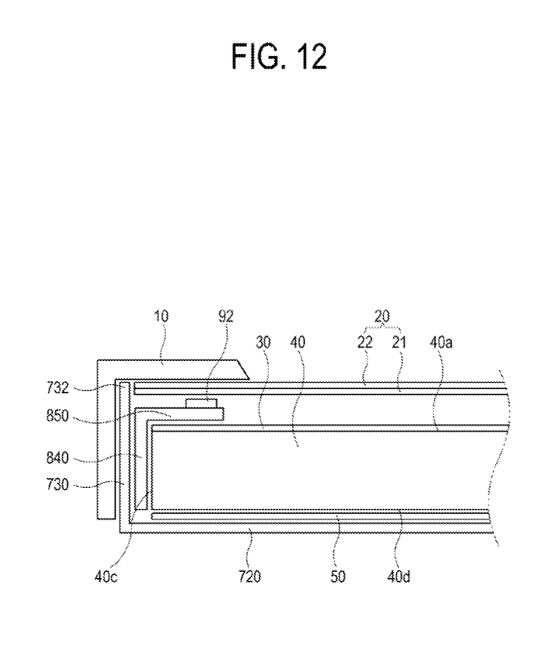

An LCD device according to an exemplary embodiment of the present invention will be described with reference to FIGS. 11 and 12.

A third part 730 of each cover member 70 includes a third panel guide 732 which protrudes more than a first part 710. The shorter side of a liquid crystal panel 20 faces the third panel guide 732. The second panel guide 851 of the side cover 80 may not be provided.

A covers member 70 includes a light guide plate stopper 733 which is extended inwardly from the third part 730. The light guide plate stopper 733 restricts the movement of the light guide plate 40 and prevents the light guide plate 40 from contacting a light source 61.

In other embodiment, the light guide plate stopper 733 may be protruded from the second part 720.

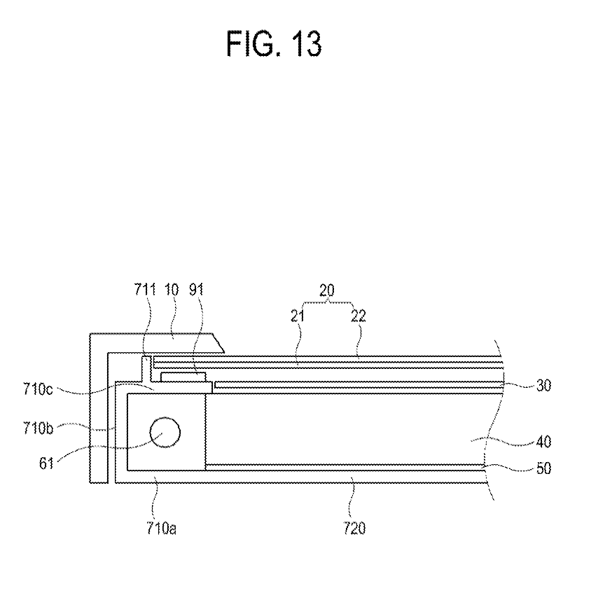

An LCD device according to an exemplary embodiment of the present invention will be described with reference to FIG. 13. Light emitted from a light source 61 is reflected in each cover member 70 to a light guide plate 40. An inside surface of each cover member 70 includes a mirror surface. The mirror surface is formed through a polishing process or an electronic beam process. Alternatively, a reflecting layer may be coated on the inside surface of each cover member 70.

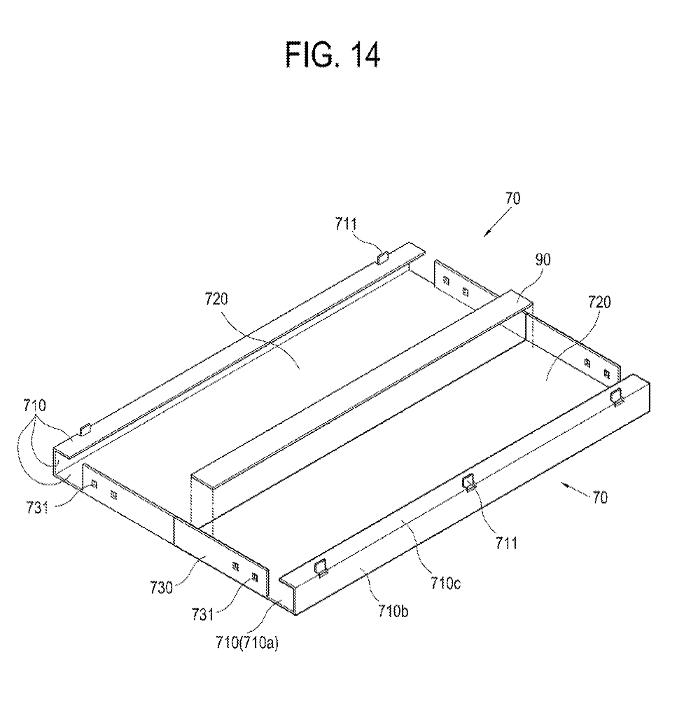

An LCD device according to an exemplary embodiment of the present invention will be described with reference to FIG. 14.

Second parts 720 of cover members 70 are relatively so long that they meet each other when assembled. That is, end parts of the second parts 720 of cover members 70 substantially contact with each other.

Although not shown, the pair of the cover members 70 can be coupled using a hook. In this case, the hook and the cover members 70 may be formed as one body.

A tape member 90 is adhered to the end parts of the second parts 720 of the cover members 70. The tape member 90 reduces light leakage and may be conductive. The tape member 90 may comprise an aluminum tape.

In this embodiment the tape member 90 is adhered to a front surface of the cover members 70. However, in other exemplary embodiment, the tape member 90 may be adhered to a back surface of the cover members 70.

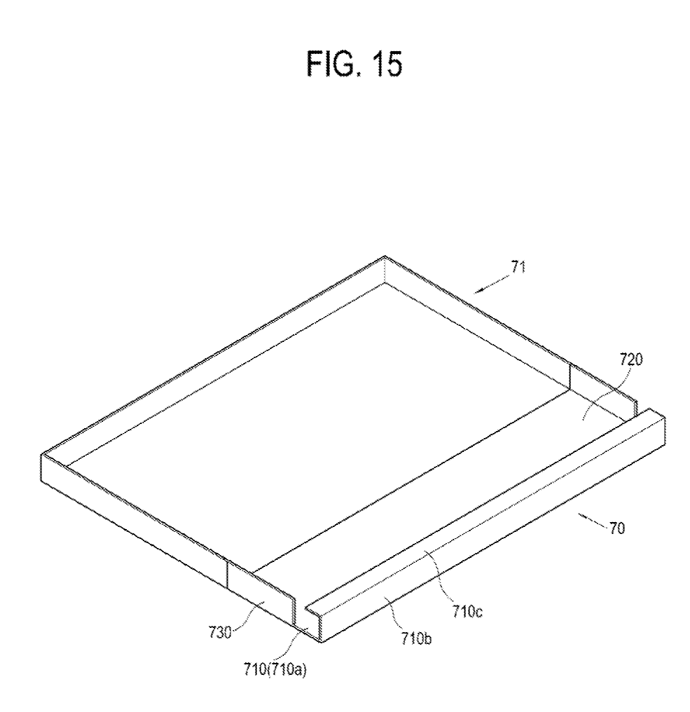

An LCD device according to an exemplary embodiment of the present invention will be described with reference to FIG. 15.

In this embodiment, a light source 61 is provided along a single side of a light guide plate 40. Accordingly, a cover member 70 accommodating the light source 61 has a different shape from a cover member 71 not accommodating the light source 61.

The cover members 70 and 71 may be coupled using a side cover 80 or a hook (not shown).

In other embodiment, a tape member may be used to adhere the cover members 70 and 71.

According to this embodiment, the light source 61 can be easily disassembled from the cover member 70.

Although exemplary embodiments of the present invention have been shown and described, it will be appreciated by those skilled in the art that changes may be made in embodiments without departing from the principles and spirit of the disclosure.

What is claimed is:

1. A liquid crystal display device, comprising:
a liquid crystal panel;
a light guide plate which is provided behind the liquid crystal panel and comprises an exit surface facing the liquid crystal panel, a reflecting surface opposite to the exit surface, a first incident surface and a pair of side surfaces opposite to each other;
a first light source provided along the first incident surface of the light guide plate; and
a cover member, the cover member comprises a first part accommodating the first light source with the first incident surface and a second part extending from the first part and facing the reflecting surface of the light guide plate, and over which the liquid crystal panel is seated.

2. The liquid crystal display device according to claim 1, further comprising a second light source provided along a second incident surface of the light guide plate and a second cover member,
the second cover member comprising an accommodating part accommodating the second light source with the second incident surface and an extending part extending from the accommodating part and facing the reflecting surface of the light guide plate, and over which the liquid crystal panel is seated, and
the first incident surface of the light guide plate and the second incident surface of the light guide plate being opposite to each other.

3. The liquid crystal display device according to claim 1, wherein the liquid crystal panel is seated over the first part, and
the first cover member further comprises a first panel guide which protrudes from the first part and faces one side part of the liquid crystal panel.

4. The liquid crystal display device according to claim 1, further comprising an elastic member provided between the first part of the first cover member and the liquid crystal panel.

5. The liquid crystal display device according to claim 4, wherein the elastic member comprises a silicon tape.

6. The liquid crystal display device according to claim 2, further comprising a pair of side covers, respectively provided along the side surfaces of the light guide plate.

7. The liquid crystal display device according to claim 6, wherein the liquid crystal panel is seated over the side covers.

8. The liquid crystal display device according to claim 1, wherein the first cover member further comprises a third part which extends from the second part and faces the side surface of the light guide plate.

9. The liquid crystal display device according to claim 8, wherein the first cover member further comprises a light guide plate stopper which extends inwardly from the third part and prevents the light guide plate from contacting the light source.

10. The liquid crystal display device according to claim 7, wherein each of the side covers comprises a fourth part which faces one of the side surfaces of the light guide plate and a fifth part which extends from the fourth part and faces the exit surface of the light guide plate, and
the liquid crystal panel is seated over the fifth part.

11. The liquid crystal display device according to claim 10, wherein each of the side covers comprises a second panel guide which extends from the fifth part and faces one side part of the liquid crystal panel.

12. The liquid crystal display device according to claim 10, further comprising an optical film provided between the light guide plate and the liquid crystal panel,
wherein a part of the optical film is provided between the light guide plate and the fifth part.

13. The liquid crystal display device according to claim 1, further comprising a light source reflecting plate which is provided between the first light source and the first cover member, and reflects light emitted from the first light source to the first incident surface of light guide plate.

14. The liquid crystal display device according to claim 1, further comprising a reflecting plate which is provided between the light guide plate and the second part of the first cover member.

15. The liquid crystal display device according to claim 2, wherein the second part of the first cover member and the extending part of the second cover member substantially meet each other.

16. The liquid crystal display device according to claim 15, further comprising a tape member adhering the second part of the first cover member and the extending part of the second cover member.

17. The liquid crystal display device according to claim 16, wherein the tape member comprises a conductive tape.

18. A liquid crystal display device, comprising:
a liquid crystal panel;
a light guide plate which is provided behind the liquid crystal panel and comprises an exit surface facing the liquid crystal panel, a reflecting surface opposite to the exit surface, a pair of incident surfaces opposite to each other, and a pair of side surfaces opposite to each other;
a pair of light sources provided along the respective incident surfaces of the light guide plate;
a pair of cover members, each of the cover members comprises a first part accommodating one of the light sources with one of the incident surfaces and a second part extending from the first part and facing the reflecting surface of the light guide plate.

19. The liquid crystal display device according to claim 18, wherein each of the cover members further comprises a third part extending from the second part and facing the side surface of the light guide plate.

20. The liquid crystal display device according to claim 19, further comprising a pair of side covers, each side cover provided along one of the side surfaces of the light guide plate and couples the pair of the cover members.

21. The liquid crystal display device according to claim 20, wherein the liquid crystal panel is seated over the cover members and the side covers.

22. The liquid crystal display device according to claim 21, further comprising an elastic member provided between the liquid crystal panel and each of the cover members, and between the liquid crystal panel and each of the side covers.

23. The liquid crystal display device according to claim 22, wherein at least a part of each of the cover members faces the exit surface of the light guide plate.

24. The liquid crystal display device according to claim 22, further comprising a panel guide facing a side part of the liquid crystal panel, the panel guide formed in the cover members and the side covers, respectively.

25. A liquid crystal display device comprising:
a liquid crystal panel;
a light guide plate provide behind the liquid crystal panel;
a light source provided along opposite incident surface of the light guide plate;
a cover member comprising at least two sub cover members being separated from each other and accommodating the light guide plate, wherein one of the sub cover members accommodates the light source with the incident surface.
